(19) United States
(12) Patent Application Publication
(10) Pub. No.: US 2023/0350036 A1
(43) Pub. Date: Nov. 2, 2023

(54) Method for Calibrating a Lighting Device and an Optical Sensor, Control Device for Carrying Out Such a Method, Calibration Device Having Such a Control Device, Motor Vehicle Having Such a Calibration Device, Calibration Marker for Use in Such a Method, Calibration Marker Arrangement Having Such a Calibration Marker and Calibration Arrangement Having Such a Calibration Marker Arrangement

(71) Applicant: Daimler Truck AG, Leinfelden-Echterdingen (DE)

(72) Inventors: Fridtjof STEIN, Ostfildern (DE); Sebastian KLEINSCHMIDT, Hannover (DE)

(21) Appl. No.: 18/245,990

(22) PCT Filed: Jul. 26, 2021
(86) PCT No.: PCT/EP2021/070885

§ 371 Date: Mar. 20, 2023

(30) Foreign Application Priority Data
Sep. 21, 2020 (DE) 10 2020 005 762.4

(51) Int. Cl. G01S 7/497; G01S 17/931

(52) U.S. Cl. CPC G01S 7/497; G01S 17/931

(57) ABSTRACT

A method for calibrating a lighting device and an optical sensor includes a control of the lighting device and the optical sensor are chronologically coordinated with each other. A visible distance region is assigned to the coordinated control. A series of recordings in chronological sequence are recorded with the optical sensor via the coordinated control when lit by the lighting device. In a recording that is chronologically first in the series, in which a calibration marker that has a pre-determined dimension is recognized, an actual distance of the calibration marker is determined using the pre-determined dimension. The coordinated control and/or the visible distance region are evaluated and/or changed on a basis of a far border of the visible distance region and the actual distance.

BACKGROUND AND SUMMARY OF THE INVENTION

The invention relates to a method for calibrating a lighting device and an optical sensor, a control device for carrying out such a method, a calibration device having such a control device, a motor vehicle having such a calibration device, a calibration marker for use in such a method, a calibration marker arrangement having such a calibration marker and a calibration arrangement having such a calibration marker arrangement.

A method for calibrating a lighting device arises from the European patent application with publication number EP 3 308 193 B 1. In this method, light pulses are emitted by means of the lighting device. These emitted light pulses are compared with a reference light pulse, and the lighting device is calibrated on the basis of this comparison. In this method, however, the interaction of lighting device and optical sensor is not considered.

A basis of calibration of a technical system is that the dimension of the environment in which the calibration is undertaken and the dimension of the environment in which the technical system is operated are as identical as possible. This can only be implemented in a cost-efficient and space-saving manner for distances of up to 200 m with significant difficulty.

The object of the invention is to create a method for calibrating a lighting device and an optical sensor, a control device for carrying out such a method, a calibration device having such a control device, a motor vehicle having such a calibration device, a calibration marker for use in such a method, a calibration marker arrangement having such a calibration marker and a calibration arrangement having such a calibration marker arrangement, wherein the specified disadvantages are at least partially alleviated, preferably avoided.

The object is in particular solved by creating a method for calibrating a lighting device and an optical sensor, wherein a control of the lighting device and the optical sensor are chronologically coordinated with each other and a visible distance region is assigned to the coordinated control. By means of the coordinated control, a series of recordings in chronological sequence is recorded with the optical sensor when lit by means of the lighting device. In the recording that is chronologically first in the series, in which at least one calibration marker that has at least one pre-determined dimension is recognized, a first actual distance of the at least one calibration marker is determined using the at least one pre-determined dimension. The coordinated control and/or the visible distance region are evaluated and/or changed on the basis of a far border of the visible distance region and the first actual distance.

With the assistance of the method suggested here, it is advantageously possible to calibrate the control of the lighting device and the optical sensor, in particular the far border of the visible distance region on the basis of a small number of distance measurements, preferably one distance measurement. The measurement precision of the lighting device and the optical sensor is thus increased and the legal requirements are fulfilled. The calibration in particular comprises the orchestration of the lighting device and the illumination control of the optical sensor.

It is additionally advantageously possible to recognize and compensate for ageing effects in the components of the lighting device and the optical sensor with the method. Additionally, a possible future failure of a component due to ageing effects is preferably recognized early on, whereupon an exchange of the respective component can be initiated.

The calibration of the lighting device and the optical sensor additionally advantageously occurs during the journey of a motor vehicle that has the lighting device and the optical sensor, in particular preferably during a journey in real conditions on a real road, in particular preferably a public road such as for example an A-road or a motorway. The dimension of the environment in which the calibration is undertaken and the dimension of the environment in which the lighting device and the optical sensor are operated are thus identical.

The calibration of the lighting device and the optical sensor ensures that ageing effects and/or contamination of the lighting device and/or the optical sensor do not distort the distance measurement. A shift in runtime of 10 ns is enough to result in an error for the distance measurement of approximately 3 m.

The method for generating recordings by means of a chronologically coordinated control of a lighting device and an optical sensor is in particular a method known as a gated image method; the optical sensor is in particular a camera that is sensitively switched only within a limited period of time, which is described as gated control, and the camera is thus a gated camera. The lighting device is also correspondingly controlled only within a particular selected period of time to light a scene on the object.

A pre-determined number of light pulses are in particular emitted by the lighting device, preferably respectively having a duration between 5 ns and 20 ns. The beginning and the end of the illumination of the optical sensor is coupled with the number and duration of the emitted light pulses. As a result, a particular visible distance region can be recorded by the optical sensor via the coordinated control of the lighting device on the one hand and the optical sensor on the other hand with correspondingly defined spatial position, i.e., in particular specific distances of a near and a far border of the visible distance region from the optical sensor.

The visible distance region is the region on the object in three-dimensional space that is depicted by the number and duration of the light pulses of the lighting device in connection with the start and the end of the illumination of the optical sensor by means of the optical sensor in a two-dimensional recording in an image plane of the optical sensor.

When the term “on the object” is used here and in the following, a region in real space, i.e., on the calibration marker to be observed, is meant. When the term “in the image” is used here and in the following, a region in the image plane of the optical sensor is meant. The visible distance region is specified on the object. This visible distance region corresponds to a region in the image in the image plane assigned via the imaging laws and the temporal control of the lighting device and the optical sensor.

Depending on the start and end of the illumination of the optical sensor after the lighting by the lighting device begins, light impulse photons hit the optical sensor. The further away the visible spacing region is from the lighting device and the optical sensor, the longer the temporal duration until a photon that is reflected in this distance region, in particular on the calibration marker within this distance region, hits the optical sensor. The temporal gap between an end of the lighting and a beginning of the illumination thus increases the further the visible spacing region is from the lighting device and from the optical sensor.

It is thus in particular possible according to an embodiment of the method to define the position and the spatial width of the visible distance region, in particular a distance between the near border and the far border of the visible distance region, via a correspondingly suitable choice of the chronological control of the lighting device on the one hand and the optical sensor on the other hand.

In a preferred embodiment of the method, the visible distance region is predetermined, wherein the chronological coordination of the lighting device on the one hand and the optical sensor on the other is determined and correspondingly pre-determined from the visible distance region.

In a further preferred embodiment of the method, the series of recordings in chronological sequence contains at least one recording that is recorded chronologically before the recording in which the at least one calibration marker is recognized for the first time, and in which no calibration marker is recognized. It is thus ensured that the at least one calibration marker is recognized first chronologically close to the far border of the visible distance region. A reliable calibration of the lighting device and the optical sensor is thus possible on the basis of the far border of the visible distance region and the first actual distance. The first actual distance is preferably compared with the distance between the optical sensor and the far border of the visible distance region. If these distances differ, then the first actual distance is preferably set as the far border of the visible distance region of the coordinated control.

The lighting device is a laser in a preferred embodiment. Alternatively or in addition, the optical sensor is preferably a camera.

In the context of the present technical teaching, the at least one-known-predetermined dimension of the at least one calibration marker is a height and/or a width and/or a surface area of the at least one calibration marker.

At least one-known-extension of the at least one calibration marker on the object is the at least one pre-determined dimension and is described by Aₒ. An extension of the at least one calibration marker in the image is described by A_{b} and can be directly determined with reference to the depiction of the at least one pre-determined dimension of the at least one calibration marker in the image plane of the optical sensor. By using the second intercept theorem, the first actual distance, which is described by Sₒ, is calculated from the extension of the at least one pre-determined dimension of the at least one calibration marker on the object and in the image and a pre-determined and known distance S_{b} present within the optical sensor using the formula (1).

$${S}_{o} = {S}_{b} \times \frac{{A}_{o}}{{A}_{b}}$$

According to a development of the invention, it is provided that a second actual distance of the at least one calibration marker is determined in the recording of the series that is chronologically the last of the sequence in which the at least one calibration marker is recognized. The coordinated control and/or the visible distance region are evaluated and/or changed on the basis of a near border of the visible distance region and the second actual distance.

It is thus advantageously possible to coordinate the control of the lighting device and the optical sensor, in particular the near border of the visible distance region, on the basis of a small number of distance measurements, preferably one distance measurement.

In a preferred embodiment of the method, the series of recordings in chronological sequence contains at least one recording that is recorded chronologically after the recording in which the at least one calibration marker is recognized for the last time, and in which a calibration marker is recognized. It is thus ensured that the at least one calibration marker is recognized last chronologically close to the near border of the visible distance region. A reliable calibration of the lighting device and the optical sensor is thus possible on the basis of the near border of the visible distance region and the second actual distance. The second actual distance is preferably compared with the distance between the optical sensor and the near border of the visible distance region. If these distances differ, then the second actual distance is preferably set as the near border of the visible distance region of the coordinated control.

In a further preferred embodiment of the method, the series of recordings in chronological sequence contains at least one recording that is recorded chronologically before the recording in which the at least one calibration marker is recognized for the first time, and in which no calibration marker is recognized. The series of recordings in chronological sequence additionally contains at least one recording that is recorded chronologically before the recording in which the at least one calibration marker is recognized for the first time, and in which no calibration marker is recognized. A reliable calibration of the lighting device and the optical sensor is thus advantageously possible on the basis of the near border and the far border of the visible distance region and the first and second actual distance.

According to a development of the invention, it is provided that in a recording in the series, in which the at least two calibration markers that have the at least one predetermined dimension are recognized, the first actual distance and the second actual distance of the at least two calibration markers are determined using the at least one pre-determined dimension. The coordinated control and/or the visible distance region are evaluated and/or changed on the basis of the far border and the near border of the visible distance region and the second actual distance.

It is thus advantageously possible to calibrate the coordinated control of the lighting device and the optical sensor, in particular the near border and the far border of the visible distance region, on the basis of a small number of distance measurements, preferably two distance measurements. The coordinated control of the lighting device and the optical sensor is preferably evaluated and/or changed such that the near border of the visible distance region corresponds to the second actual distance and that the far border of the visible distance region corresponds to the actual first distance.

Alternatively, the visible distance region is evaluated and/or changed such that, with an additional distance determination of the at least two calibration markers based on the near border and the far border of the visible spacing region, in particular as described in the German application DE 10 2020 002 994 A1, calculated distances are identical to the first actual distance and the second actual distance.

According to a development of the invention, it is provided that the coordinated control of the lighting device and the optical sensor changes such that the associated visible distance region is enlarged by a pre-determined factor if at least two calibration markers are not recognized in any recording of the series. A visible distance region is thus advantageously recognized as too narrow, and broadened by means of a pre-determined factor.

In an embodiment of the method, the enlargement of the visible distance region corresponds to a pre-calibration of the lighting device and the optical sensor by a pre-determined factor. As soon as two calibration markers are recognized in at least one recording in a further series, the actual calibration of the lighting device and the optical sensor occurs.

According to a development of the invention, it is provided that an actual number of the photons arriving at the optical sensor is measured. On the basis of a difference between the actual number and a target number of photons arriving at the optical sensor, the lighting intensity of the lighting device is evaluated and/or changed. The reflective properties of the at least one calibration marker are preferably known for the evaluation of the actual number of arriving photons.

A calibration of the lighting intensity of the lighting device is preferably also carried out in addition to the calibration of the near border and the far border of the visible distance region. Overall, the calibration of the lighting device and the optical sensor comprises adjustment of the electronics and/or adjustment of the lighting pulse duration and/or adjustment of the lighting pulses and/or calculation of latencies induced by the electronics.

According to a development of the invention, it is provided that the lighting device as a first lighting device, and additionally a second lighting device are alternately used for lighting. It is thus advantageously possible to calibrate a combination of the optical sensor, the first lighting device and the second lighting device.

The object is also solved by creating a control device that is equipped to carry out a method according to the invention or a method according to one of the previously described embodiments. The control device is preferably designed as a computing device, in particular preferably as a computer or as a control device, in particular as a control device of a motor vehicle. In particular, the advantages that have already been explained in connection with the method arise in connection with the control device.

The control device is preferably in operative connection with the at least one lighting device and the optical sensor, and equipped for their respective control.

The object is also solved by creating a calibration device that has at least one lighting device, an optical sensor and a control device according to the invention or a control device according to one of the previously described embodiments. In particular the advantages that have already been explained in connection with the method and the control device arise in connection with the calibration device.

The object is also solved by creating a calibration device according to the invention or a calibration device according to one of the previously described embodiments. In particular. the advantages that have already been explained in connection with the method, the control device and the calibration device arise in connection with the motor vehicle.

In an advantageous embodiment, the motor vehicle is designed as a heavy goods vehicle. It is also possible, however, that the motor vehicle is a passenger car, a commercial vehicle or another motor vehicle.

The object is also solved by creating a calibration marker that is equipped to be used in a method according to the invention or a method according to one of the previously described embodiments. The calibration marker has at least one pre-determined dimension. The calibration marker additionally has at least one feature, selected from a group consisting of an identification feature, an optical feature for determining at least one optical parameter, and a lighting feature for determining a lighting intensity in the case of a known reflectivity of the lighting feature. In particular, the advantages that have already been explained in connection with the method arise in connection with the calibration marker.

In a preferred embodiment, the calibration marker is rectangular shaped. The calibration marker additionally has a pre-determined width. Alternatively or in addition, the calibration marker has a pre-determined height. Alternatively or in addition, the calibration marker has a pre-determined surface area.

In a preferred embodiment, the calibration marker has a light background colour, in particular white. Alternatively or in addition, the calibration marker has a light, in particular a white, peripheral line along the periphery and a dark, in particular a black, peripheral line. The light peripheral line can be easily recognized and measured in a recording, in particular in contrast with the dark peripheral line.

In a preferred exemplary embodiment, the identification feature is a QR code with which at least one piece of information selected from a group consisting of the pre-determined dimension, a number of the calibration marker, a position of the calibration marker and the reflective properties of the calibration marker can be requested or in which the at least one piece of information is coded.

The object is also solved by creating a calibration marker arrangement having a first calibration marker and a second calibration marker, wherein the first calibration marker and the second calibration marker are respectively created as calibration markers according to the invention or as calibration markers according to one of the previously described exemplary embodiments. The first calibration marker and the second calibration marker additionally have a pre-determined spatial distance. In particular the advantages that have already been explained in connection with the method and the calibration marker arise in connection with the calibration marker arrangement.

According to a preferred embodiment, the calibration marker arrangement is set up on a road regularly driven on by a motor vehicle to be calibrated, i.e., a motor vehicle having a lighting device and optical sensor to be calibrated, in real operation. The road can be a private road, in particular on company land, a test route or in particular a public road, for example an A-road or a motorway. In this way, the motor vehicle can be calibrated particularly easily in real operation.

The control of the lighting device and the optical sensor is advantageously adjusted such that the associated visible distance region has a width that corresponds to the pre-determined distance between the first calibration marker and the second calibration marker.

The object is finally also solved by creating a calibration arrangement having a first calibration marker arrangement, a second calibration marker arrangement and a third calibration marker arrangement, wherein the first calibration marker arrangement, the second calibration marker arrangement and the third calibration marker arrangement are respectively designed as calibration marker arrangements according to the invention or as calibration marker arrangements according to one of the previously described exemplary embodiments. The first calibration marker arrangement and the second calibration marker arrangement additionally have a pre-determined spatial distance from each other, and the second calibration marker arrangement and the third calibration marker arrangement have a pre-determined spatial distance from each other. The advantages in particular arise in connection with the calibration arrangement which have already been explained in connection with the method, the calibration marker and the calibration marker arrangement.

According to a preferred embodiment, the calibration arrangement is set up on a road driven along regularly by a motor vehicle to be calibrated in real operation. The road can be a private road, in particular on company land, a test route or in particular a public road, for example an A-road or a motorway. In this way, the motor vehicle can be calibrated particularly easily in real operation.

The invention is explained in the following with reference to the drawings.

### BRIEF DESCRIPTION OF THE DRAWINGS

FIG. 1 shows a schematic depiction of a first exemplary embodiment of a motor vehicle and a first exemplary embodiment of a calibration marker and a far border of a visible distance region;

FIG. 2 shows a schematic depiction of the first exemplary embodiment of the motor vehicle and a first exemplary embodiment of a calibration marker and a near border of the visible distance region;

FIG. 3 shows a schematic depiction of the first exemplary embodiment of a motor vehicle and a first exemplary embodiment of a calibration marker arrangement;

FIG. 4 shows a schematic depiction of a second exemplary embodiment of a motor vehicle and the first exemplary embodiment of a calibration marker;

FIG. 5 shows a schematic depiction of the first exemplary embodiment of a motor vehicle and an exemplary embodiment of a calibration arrangement having calibration markers of a second exemplary embodiment;

FIG. 6 shows a schematic depiction of an intake of an optical sensor of a second exemplary embodiment of a calibration marker arrangement having two calibration markers of a third exemplary embodiment; and

FIG. 7 shows a schematic depiction of a fourth exemplary embodiment of a calibration marker.

### DETAILED DESCRIPTION OF THE DRAWINGS

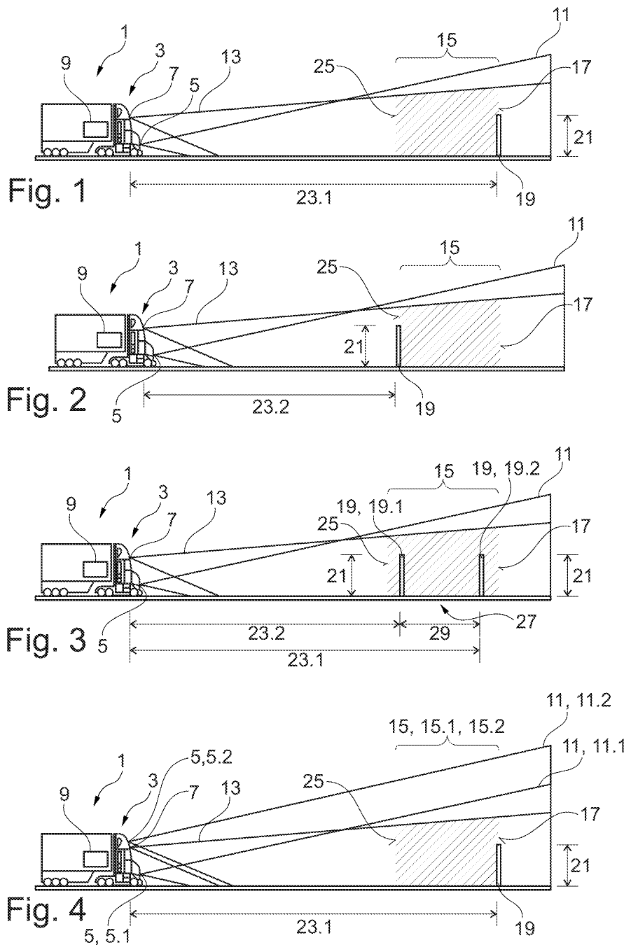

FIG. 1 shows a schematic depiction of a first exemplary embodiment of a motor vehicle 1 having a calibration device 3. The calibration device 3 has a lighting device 5, preferably a laser, an optical sensor 7, preferably a camera, and a control device 9. The control device 9 is only schematically depicted here, and is not operatively connected in an explicitly depicted manner to the lighting device 5 and the optical sensor 7, and equipped for their respective control. In FIG. 1, a lighting frustum 11 of the lighting device 5 and an observation region 13 of the optical sensor 7 are in particular depicted. A visible distance region 15 is additionally depicted cross-hatched, which results as a partial quantity of the observation region 13 of the optical sensor 7 and the lighting frustum 11 of the lighting device 5.

In the visible spacing region 15, in particular on a far border 17 of the visible distance region 15, a first exemplary embodiment of a calibration marker 19 is arranged. The calibration marker 19 has a pre-determined dimension 21, in particular a pre-determined height.

The control device 9 is in particular equipped to carry out an embodiment of a method for calibrating the lighting device 5 and the optical sensor 7, described in more detail in the following.

The lighting device 5 and the optical sensor 7 are controlled in a manner chronologically coordinated with one another, wherein a spatial position of the visible distance region 15 in the observation region 13 is specified from the chronological coordination of the control of the lighting device 5 and the optical sensor 7. A series of recordings 35 in chronological sequence are recorded with the optical sensor 7 by means of the coordinated control when lit by means of the lighting device 5.

In a recording 35 that is chronologically first in the series, in which the calibration marker 19 that has the pre-determined dimension 21, in particular the pre-determined height, is recognized, a first actual distance 23.1 of the calibration marker 19 is determined using the pre-determined dimension 21. To determine the first actual distance 23.1 of the calibration marker 19, an extension of the pre-determined dimension 21 in the image in the recording 35 that is chronologically the first in the series in which the calibration marker 19 is recognized is determined. FIG. 1 shows the point in time at which the recording 35 that is chronologically the first in the series in which the calibration marker 19 is recognized, is recorded. Based on the pre-determined dimension 21 and the extension of the pre-determined dimension 21 in the image, the first actual distance 23.1 is calculated using the formula (1).

The coordinated control and/or the visible distance region 15 are evaluated and/or changed on the basis of a far border 17 of the visible distance region 15 and the first actual distance 23.1.

In a preferred embodiment of the method, the series of recordings 35 in chronological sequence contains at least one recording 35 that is recorded chronologically before the recording 35 in which the calibration marker 19 is recognized for the first time, and in which no calibration marker 19 is recognized. It is thus ensured that the calibration marker 19 is recognized first chronologically close to the far border 17 of the visible distance region 15. And thus, a reliable calibration of the lighting device 5 and the optical sensor 7 is possible on the basis of the far border 17 of the visible distance region 15 and the first actual distance 23.1. The first actual distance 23.1 is preferably compared with the distance between the optical sensor 7 and the far border 17 of the visible distance region 15. If these distances differ, then the first actual distance 23.1 is preferably set as the far border 17 of the visible distance region 15 of the coordinated control.

FIG. 2 shows a schematic depiction of the first exemplary embodiment of a motor vehicle 1, as depicted in FIG. 1.

In the visible spacing region 15, in particular on a near border 25 of the visible distance region 15, the first exemplary embodiment of the calibration marker 19 is arranged. Analogously to FIG. 19, the calibration marker 19 has the pre-determined dimension 21, in particular the pre-determined height.

The control device 9 is in particular equipped to carry out a development of the method for calibrating the lighting device 5 and the optical sensor 7 described in more detail in the following.

In a recording 35 that is chronologically last in the series, in which the calibration marker 19 that has the pre-determined dimension 21, in particular the pre-determined height, is recognized, a second actual distance 23.2 of the calibration marker 19 is determined using the pre-determined dimension 21. To determine the second actual distance 23.2 of the calibration marker 19, an extension of the pre-determined dimension 21 in the image in the recording 35 that is chronologically the last in the series in which the calibration marker 19 is recognized is determined. FIG. 2 shows the point in time at which the recording 35 that is chronologically the last in the series in which the calibration marker 19 is recorded, is recognized. Based on the pre-determined dimension 21 and the extension of the pre-determined dimension 21 in the image, the second actual distance 23.2 is calculated using the formula (1).

The coordinated control and/or the visible distance region 15 are evaluated and/or changed on the basis of a near border 25 of the visible distance region 15 and the second actual distance 23.2.

In a preferred embodiment of the method, the series of recordings 35 in chronological sequence contains at least one recording 35 that is recorded chronologically after the recording 35 in which the calibration marker 19 is recognized for the last time, and in which no calibration marker 19 is recognized. It is thus ensured that the calibration marker 19 is recognized last chronologically close to the near border 25 of the visible distance region 15. And thus, a reliable calibration of the lighting device 5 and the optical sensor 7 is possible on the basis of the near border 25 of the visible distance region 15 and the second actual distance 23.2. The second actual distance 23.2 is preferably compared with the distance between the optical sensor 7 and the near border 25 of the visible distance region 15. If these distances differ, then the second actual distance 23.2 is preferably set as the near border 25 of the visible distance region 15 of the coordinated control.

FIG. 3 shows a schematic depiction of the first exemplary embodiment of a motor vehicle 1, as depicted in FIG. 1 and FIG. 2.

In the visible distance region 15, a first exemplary embodiment of a calibration marker arrangement 27 is arranged. The calibration marker arrangement 27 has the first exemplary embodiment of a first calibration marker 19.1 and a first exemplary embodiment of a second calibration marker 19.2, wherein the first calibration marker 19.1 and the second calibration marker 19.2 have a pre-determined spatial distance 29 from each other. Analogously to FIG. 1, the first calibration marker 19.1 and the second calibration marker 19.2 have the pre-determined dimension 21, in particular the pre-determined height.

The control device 9 is in particular equipped to carry out a development of the method for calibrating the lighting device 5 and the optical sensor 7 described in more detail in the following.

In a recording 35 of the series in which the calibration marker arrangement 27, in particular the first calibration marker 19.1 and the second calibration marker 19.2, are recognized, the first actual distance 23.1 and the second actual distance 23.2 of the calibration markers 19 are determined with reference to the pre-determined dimension 21. To determine the first actual distance 23.1 and the second actual distance 23.2 of the calibration markers 19, the extensions of the pre-determined dimension 21 in the image in a recording 35 of the series in which the calibration marker arrangement 27, in particular the first calibration marker 19.1 and the second calibration marker 19.2, are recognized are determined analogously to FIG. 1 and FIG. 2. FIG. 3 shows a point in time at which the calibration marker arrangement 27, in particular the first calibration marker 19.1 and the second calibration marker 19.2, are recognized in a recording 35. Based on the pre-determined dimension 21 and the extensions of the pre-determined dimension 21 in the image, the first actual distance 23.1 and the second actual distance 23.2 are calculated using the formula (1).

The coordinated control and/or the visible distance region 15 are evaluated and/or changed on the basis of the far border 25 and the near border 17 of the visible distance region 15, the first actual distance 23.1 and the second actual distance 23.2.

The coordinated control of the lighting device 5 and the optical sensor 7 is preferably evaluated and/or changed such that the near border 25 of the visible distance region corresponds to the visible spacing region 15 of the second actual distance 23.2 and that the far border 17 of the visible distance region 15 corresponds to the actual first distance region 23.1.

Alternatively, the visible distance region 15 is evaluated and/or changed such that distances from the first calibration marker 19.1 and the second calibration marker 19.2, which are calculated with an additional distance determination based on the near border and the far border of the visible spacing region, in particular as described in the German application DE 10 2020 002 994 A1, are identical to the first actual distance 23.1 and the second actual distance 23.2.

If no recording 35 is contained within the series of recordings 35 in chronological sequence in which the entire calibration marker arrangement 27, in particular the first calibration marker 19.1 and the second calibration marker 19.2, is recognized, then the control is changed such that the associated visible distance region 15 is enlarged by a pre-determined factor.

FIG. 4 shows a schematic depiction of a second exemplary embodiment of a motor vehicle 1 having a calibration device 3. The calibration device 3 has a first lighting device 5.1, a second lighting device 5.2, the optical sensor 7 and the control device 9. The control device 9 is only schematically depicted here, and is not operatively connected in an explicitly depicted manner to the first lighting device 5.1, the second lighting device 5.2 and the optical sensor 7, and equipped for their respective control. A first lighting frustum 11.1 of the first lighting device 5.1, a second lighting frustum 11.2 of the second lighting device 5.2 and the observation region 13 of the optical sensor 7 are in particular depicted in FIG. 4. A first visible spacing region 15.1 and a second visible spacing region 15.2 that are identical and are thus described as visible distance regions 15 in the following are additionally depicted cross-hatched.

In the visible spacing region 15, in particular on a far border 17 of the visible distance region 15, a first exemplary embodiment of a calibration marker 19 is arranged. The calibration marker 19 has the pre-determined dimension 21, in particular the pre-determined height.

The control device 9 is in particular equipped to carry out a modified form of the exemplary embodiment of a method previously described in more detail for calibrating the first lighting device 5.1, the second lighting device 5 and the optical sensor 7. The only difference from the method presented in FIGS. 1 to 3 is that the first lighting device 5.1 and the second lighting device 5.2 are alternately used to light the observation region 13.

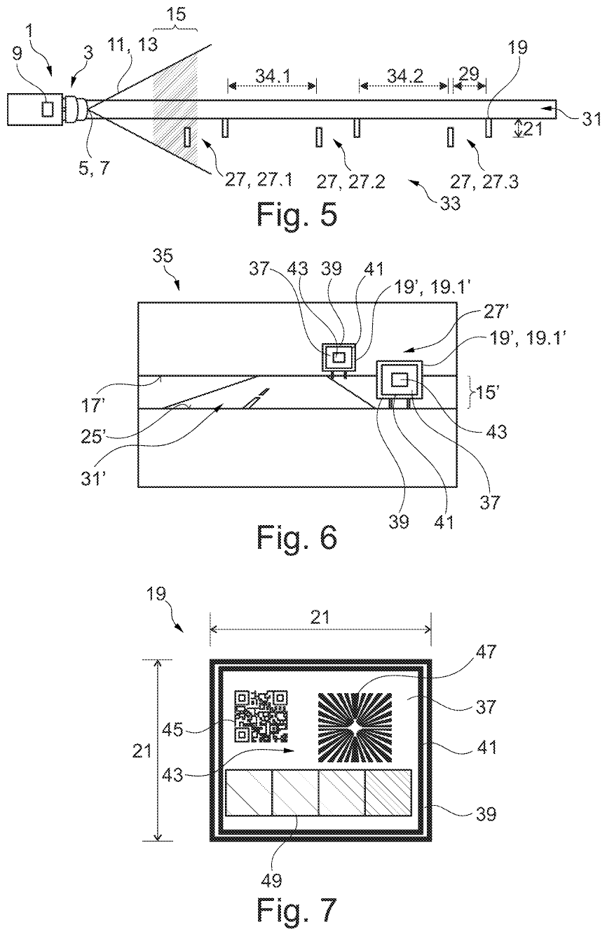

FIG. 5 shows a schematic depiction of the first exemplary embodiment of a motor vehicle 1 on a road 31. An exemplary embodiment of a calibration arrangement 33 having a first calibration marker arrangement 27.1, a second calibration marker arrangement 27.2 and a third calibration marker arrangement 27.3 is arranged next to the road 31. The respective calibration marker arrangements 27 are spatially spaced apart from one another.

The calibration marker arrangements 27 respectively have two calibration markers 19, having a pre-determined extension 21, in particular a pre-determined width, as second exemplary embodiments of a calibration marker 19. For a clearer depiction, only one calibration marker 19 is provided with a reference numeral. The two calibration markers 19 of a calibration marker arrangement 27 have a first distance 29. This distance is identical for all three calibration marker arrangements 27.

A second distance 34.1 between the first calibration marker arrangement 27.1 and the second calibration marker arrangement 27.2 and a third distance 34.2 between the second calibration marker arrangement 27.2 and the third calibration marker arrangement 27.3 are selected and/or pre-determined such that the second distance 31.1 and the third distance 34.2 are larger than the first distance 29 by a pre-determined factor. It is thus ensured that at most the two calibration markers 19 per calibration marker arrangement 27 are recognized in a recording.

By means of each of the calibration markers 19, one of the methods previously described in more detail for calibrating the lighting device 5 and the optical sensor 7 can be carried out. Alternatively or in addition, the method previously described in more detail for calibrating the lighting device 5 and the optical sensor 7 can be carried out by means of each of the calibration marker arrangements 27 with a recording 35 in which the two calibration markers 19 of the calibration marker arrangement 27 are respectively recognized. If the motor vehicle 1 reaches the third calibration marker arrangement 27.3 and a calibration of the lighting device 5 and the optical sensor 7 is still necessary, a manual calibration and maintenance is indicated. The necessary maintenance can be shown to the driver of the motor vehicle 1 by means of a suitable device.

In a preferred exemplary embodiment of the calibration arrangement 33, a second distance 34.1 between the first calibration marker arrangement 27.1 and the second calibration marker arrangement 27.2 is identical to a third distance 34.2 between the second calibration marker arrangement 27.1 and the third calibration marker arrangement 27.3.

In a further exemplary embodiment of the calibration arrangement 33, the individual calibration marker arrangements 27 are installed on different sides of the road 31. It can then advantageously be checked whether lighting with the lighting device 5 is occurring evenly.

In an embodiment of the method from FIGS. 1 to 5, an actual number of photons arriving at the optical sensor 7 is measured. On the basis of a difference between the actual number and a target number of photons arriving at the optical sensor 7, a lighting intensity of the lighting device 5 is evaluated and/or changed.

FIG. 6 shows a schematic depiction of a recording 35 of a second embodiment of a calibration marker arrangement 27′ during lighting by means of the lighting device 5 having the optical sensor 7 by means of the coordinated control.

The calibration marker arrangement 27′ in the image, in particular two calibration markers 19, 19′ in the image, can be seen next to the road 31′ in the image. The calibration markers 19, 19′ represent a third exemplary embodiment of a calibration marker 19. The calibration markers 19, 19′ are rectangular shaped and have at least one pre-determined dimension 21, in particular a pre-determined height and/or a pre-determined width and/or a pre-determined surface area. The calibration markers 19, 19′ additionally have a light background colour 37, in particular white. In addition, the calibration markers 19, 19′ have a light, in particular a white, peripheral line 39 along the periphery and a dark, in particular a black, peripheral line 41. The light peripheral line 39 can advantageously be easily recognized and measured in the recording 35, in particular in contrast with the dark peripheral line 41.

The calibration markers 19, 19′ additionally have a feature 43. The feature 43 is an identification feature 45 and/or an optical feature 47 for determining at least one optical parameter and/or a lighting feature 49 for determining a lighting intensity. In a preferred embodiment, the identification feature 45 is a QR code with which at least one piece of information selected from a group consisting of the pre-determined dimension 21, a number of the calibration marker, a position of the calibration marker 19, 19′, the position of the calibration marker 19, 19′ and reflective properties of the calibration marker 19, 19′ can be requested or in which the at least one piece of information is coded.

The visible distance region 15′ is delimited by the far border 17′ in the image and the near border 25′ in the image. The recording 35 corresponds to a recording which is recorded in a method according to FIG. 3 or FIG. 5.

FIG. 7 shows a schematic depiction of a fourth exemplary embodiment of a calibration marker 19. The calibration marker 19 has at least one pre-determined dimension 21, in particular a pre-determined height and/or a pre-determined width and/or a pre-determined surface area. The calibration marker 19 additionally has a light background colour 37, in particular white. In addition, the calibration marker 19 has a light, in particular a white, peripheral line 39 along the periphery and a dark, in particular a black, peripheral line 41. The light peripheral line 39 can advantageously be easily recognized and measured in the recording 35, in particular in contrast with the dark peripheral line 41.

The calibration marker 19 additionally has a feature 43. The feature 43 consists of an identification feature 45 and an optical feature 47 for determining at least one optical parameter and a lighting feature 49 for determining a lighting intensity in the case of a known reflectivity of the lighting feature 49.

1.-12. (canceled)

13. A method for calibrating a lighting device (5) and an optical sensor (7), comprising:
a control of the lighting device (5) and the optical sensor (7) are chronologically coordinated with each other;
a visible distance region (15) is assigned to the coordinated control;
a series of recordings (35) in chronological sequence are recorded with the optical sensor (7) via the coordinated control when lit by the lighting device (5);
in a recording (35) that is chronologically first in the series, in which a first calibration marker (19) that has at least one pre-determined dimension (21) is recognized, a first actual distance (23.1) of the first calibration marker (19) is determined using the at least one pre-determined dimension (21); and
the coordinated control and/or the visible distance region (15) are evaluated and/or changed on a basis of a far border (17) of the visible distance region (15) and the first actual distance (23.1).

14. The method according to claim 13, wherein:
in a recording (35) that is chronologically last in the series, in which a second calibration marker (19) that has the at least one pre-determined dimension (21) is recognized, a second actual distance (23.2) of the second calibration marker (19) is determined using the at least one pre-determined dimension (21); and
the coordinated control and/or the visible distance region (15) are evaluated and/or changed on a basis of a near border (25) of the visible distance region (15) and the second actual distance (23.2).

15. The method according to claim 14, wherein:
in a recording (35) in the series, in which the first and the second calibration markers (19) are recognized, the first actual distance (23.1) and the second actual distance (13.2) of the respective first and the second calibration markers (19) are determined using the at least one pre-determined dimension (21); and
the coordinated control and/or the visible distance region (15) are evaluated and/or changed on the basis of the far border (17) and the near border (25) of the visible distance region (15), the first actual distance (23.1), and the second actual distance (23.2).

16. The method according to claim 14, wherein, if the series of the first and the second calibration markers (19) is not recognized in any of the recordings (35), the coordinated control changes such that the assigned visible distance region (15) is enlarged by a pre-determined factor.

17. The method according to claim 13, wherein an actual number of photons arriving at the optical sensor (7) is measured and wherein a lighting intensity of the lighting device (5) is evaluated and/or changed on a basis of a difference between the actual number and a target number of photons arriving at the optical sensor (7).

18. The method according to claim 13, wherein the lighting device (5) has a first lighting device (5.1) and a second lighting device (5.2) that are alternately used to light an observation region (13).

19. The method according to claim 13, wherein the calibration marker (19) has at least one of an identification feature (45), an optical feature (47) for determining at least one optical parameter, and a lighting feature (49) for determining a lighting intensity.

20. The method according to claim 14, wherein the first calibration marker (19) and the second calibration marker (19) have a pre-determined spatial distance (29) from each other.

21. A control device (9) configured to perform the method according to claim 13.

22. A calibration device (3), comprising:
a lighting device (5);
an optical sensor (7); and
a control device (9) configured to perform the method according to claim 13.
